(19) United States
(12) Patent Application Publication
(10) Pub. No.: US 2020/0023211 A1
(43) Pub. Date: Jan. 23, 2020

(54) FALL PROTECTION DEVICE

(71) Applicant: Tian Hsing Chang, Taoyuan City (TW)

(72) Inventor: Tian Hsing Chang, Taoyuan City (TW)

(21) Appl. No.: 16/040,541

(22) Filed: Jul. 20, 2018

(51) Int. Cl. A62B 35/00; B65H 75/30

(52) U.S. Cl. CPC A62B 35/0093; B65H 75/30

(57) ABSTRACT

The fall protection device includes a main member having a chamber inside. An axle runs across the chamber. A rotary disc and a brake member synchronously spin around the axle. The rotary disc has a cylinder with an axial channel, where the axle runs through the axial channel, and a roll of safety belt wraps around the cylinder. A ratchet ring is configured on the main member having teeth along an inner wall and a greater diameter than that of the cylinder. The ratchet ring is joined to the main member through a flexible band. When the safety belt pulls the rotary disc to accelerate until the brake member engages the ratchet ring's inner teeth, the flexible band slows down the ratchet ring's rotation.

### BACKGROUND OF THE INVENTION

### (a) Technical Field of the Invention

The present invention is generally related safety devices, and more particular to a fall protection device having built-in cushion mechanism

### (b) Description of the Prior Art

US09861841B1 teach a fall protection device involving a retard member 30 spinning around a shaft lever 20. The retard member 30 has an end fixed to a brake assembly 60, and has a friction surface 31 coupled to an inner wall 440 of a rotary drum 40. A safety belt 200 wraps around an outer wall 460 of the rotary drum 40. The safety belt 200 ties to a worker. When the worker falls, the retard member 30 does not move but the rotary drum 40 spins relatively to the retard member 30. The friction between the friction surface 31 and the inner wall 440 slows down the spin of the rotary drum 40, and the pull of the safety belt 200.

However, as the rotary drum 40 is driven by the safety belt 200 to spin relatively to the retard member 30, the force arm provided by the safety belt 200 is much greater than that of the resistance arm provided by the retard member 30. Further, under the influence of gravity acceleration of the worker's fall, the friction surface 31 would soon be worn out and the retard member 30 would fail to slow down the rotary drum 40. In other word, US09861841B1 has a problem of short and limited cushion effect. In addition, US09861841B1 also has the problem of difficult recycling. The axle 20, the retard member 30, and the rotary drum 40 have high replacement cost. The frame 10 and the brake assembly 60 are even more difficult to dismantle.

US 09670980B2, titled “Energy absorber and fall arrest system safety device,” does not suffer the problem of short and limited cushion effect. It has a tolerance ring 4 disposed between the rotary drum and the axle to slow down the spin of the rotary drum. However, as the tolerance ring 4 is configured between the axle and the rotary drum, it provides a much shorter resistance arm compared to the force arm provided by the outer diameter of the rotary drum. The tolerance ring 4 therefore may only sustain a limited torque, and its stability to handle the torque is compromised due to a smaller contact area.

### SUMMARY OF THE INVENTION

The present invention teaches a fall protection device that resolves the drawbacks of US 09670980B2 and US09861841B1.

The fall protection device includes a main member having a chamber inside. An axle runs across the chamber. A rotary disc and a brake member synchronously spin around the axle. The rotary disc has a cylinder with an axial channel, where the axle runs through the axial channel, and a roll of safety belt wraps around the cylinder. A ratchet ring is configured on the main member having teeth along an inner wall and a greater diameter than that of the cylinder. The ratchet ring is joined to the main member through a flexible band. When the safety belt pulls the rotary disc to accelerate until the brake member engages the ratchet ring's inner teeth, the flexible band slows down the ratchet ring's rotation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective breakdown diagram showing a fall protection device according to an embodiment of the present invention.

FIG. 2 is a perspective diagram showing a first cover, a metallic ring, a ratchet ring, and a band of the fall protection device of FIG. 1.

FIG. 3 is a perspective diagram showing the assembly of the components of FIG. 2.

FIG. 4 is a side-view diagram showing the fall protection device of FIG. 1.

FIG. 5 is a sectional diagram showing a main member of the fall protection device of FIG. 1 (the band of the fall protection device is not sectioned).

FIG. 6 is a cross-sectional diagram showing a pawl block engaging a ratchet ring's teeth.

FIG. 7 is a partially enlarged diagram showing an area C of FIG. 6.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

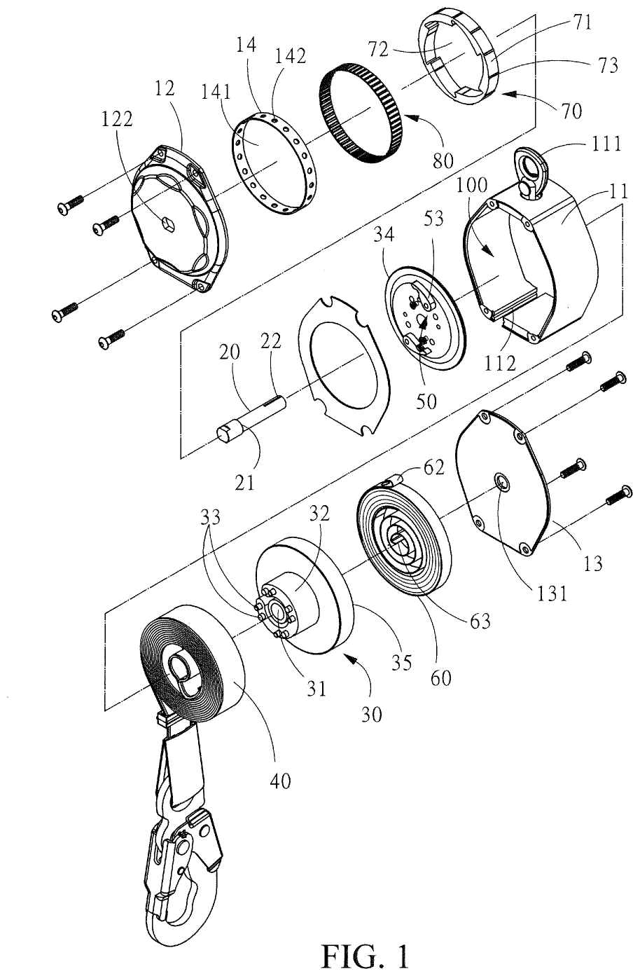

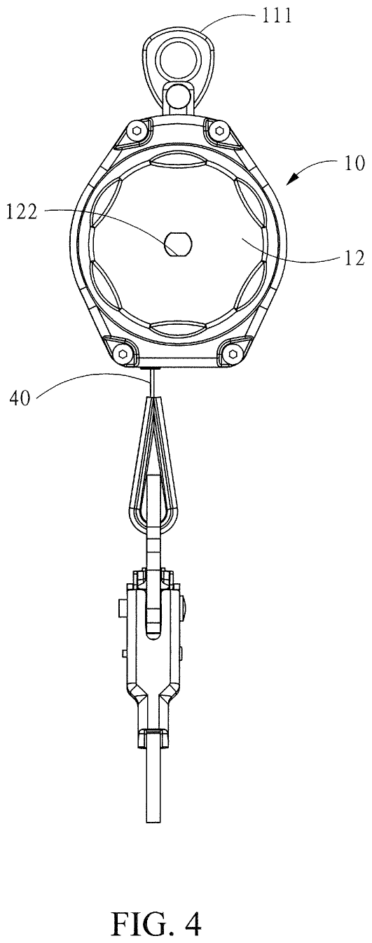

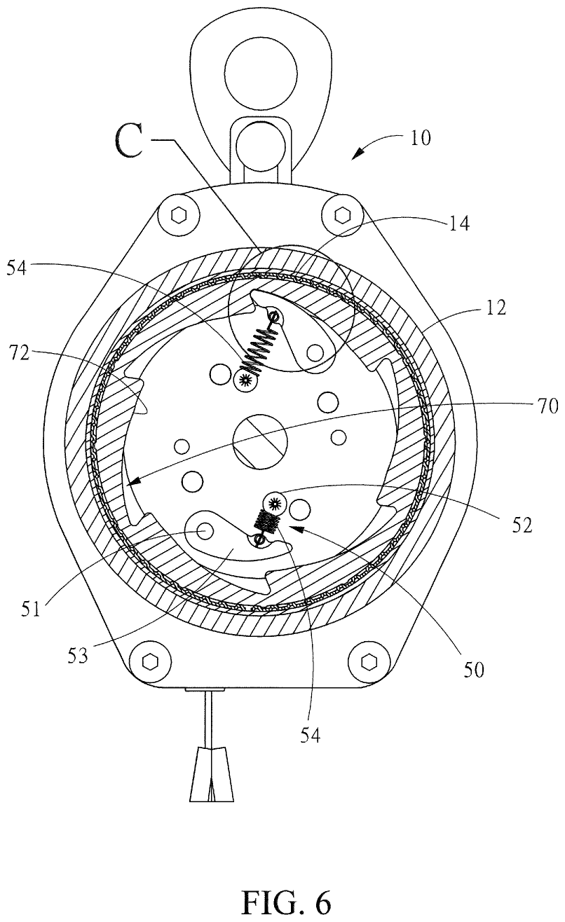

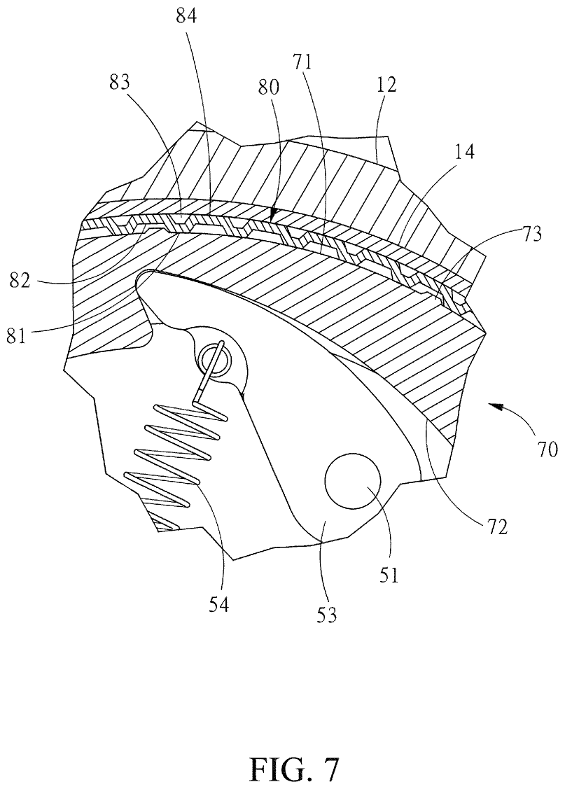

As shown in FIGS. 1 to 7, the fall protection device according to an embodiment of the present invention includes the following components.

A main member 10 includes a casing 11, a first cover 12, a second cover 13, and a metallic ring 14. The casing 11 provides opening front and back sides and a chamber 100 in between. The first cover 12 is detachably joined to the front side and the second cover 13 is detachably joined to the back side, thereby sealing the chamber 100 inside the main member 10. The casing 11 has a hanging ring 111 on a top side for connection to an anchorage and a belt slit 112 on a bottom side. The metallic ring 14 is embedded into an indentation on an inner side of the first cover 12. In terms of manufacturing, the metallic ring 14 is placed in a plastic mold for the first cover 12. Then, the metallic ring 14 is coupled to the first cover 12 when the first cover 12 is formed through integral molding. The metallic ring 14 encloses a circular space 141 and has a number of radial plug holes 142 at intervals along the metallic ring 14. Correspondingly, an inner wall of the indentation of the first cover 12 has a number of blocks 121. The blocks 121 are embedded into the plug holes 142 so that the metallic ring 14 is reliably joined to the first cover 12. The first cover 12 has a first axle hole 122 in the center and the second cover 13 has a matching second axle hole 131.

An axle 20 is fixedly housed in the chamber 100 with a front end plugging into the first axle hole 122 and a back end plugging into the second axle hole 131. The axle 20 has an radially protruding limitation element 21 adjacent to a front end of the axle 20, and an axial assembly slit 22 along a back section of the axle 20.

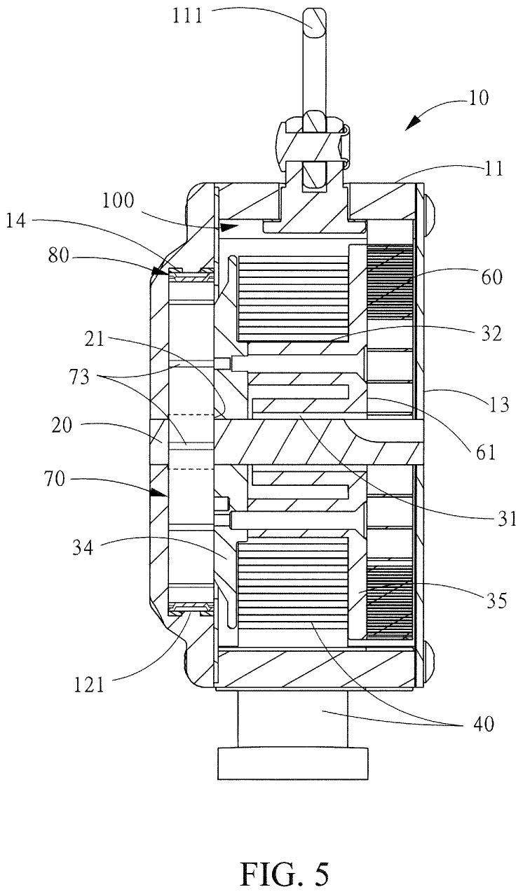

A rotary disc 30 is housed in the chamber 100 and has a cylinder 32 with an axial channel 31 running through the cylinder 32. The axle 20 runs through the channel 31. The cylinder 32's front side has a number of bolts 33 for engaging a first side plate 34. Aback side of the cylinder 32 is joined to a second side plate 35. The first side plate 34, the cylinder 32, and the second side plate 25 jointly form a ring space for accommodating a roll of safety belt 40. The safety belt 40 has an end bound to the cylinder 32 and another end running through the slit 112 of the casing 11 for connection to a user's safety harness. As shown in FIGS. 1 and 5, the first side plate 34 is stopped by the limitation element 21, and the second side plate 35 is attached to the second cover 13. Therefore, the rotary disc 30 is confined between the limitation element 21 and the second cover 13, and the rotary disc 30 does not move axially as it spins around the axle 20.

A brake member 50 housed in the circular space 141, as shown in FIGS. 1, 6, and 7, includes two pivots 51 and two spring bases 52 oppositely positioned on a front side of the first side plate 34. A pawl block 53 is pivotally mounted on each pivot 51, and a resilient spring 54 is configured between each spring base 52 to a pawl block 53 so that the pawl block 53 is by default held towards the spring base 52. When the safety belt 40 is pulled due to a fall accident and the rotary disc 30 accelerates to a specific speed, the pawl blocks 53 would conquer the springs 54 to engage teeth 72 (described later).

A spiral spring 60, as shown in FIGS. 1 to 5, is housed in an indentation 61 on a back side of the second side plate 35. The spiral spring 60 has an outer end 62 bound to an inner wall of the indentation 61, and an inner end 63 connected to the assembly slit 22 of the axle 20. As such, the rotary disc 30 is positioned at an angle in the chamber 100 so that the safety belt 40 does not run freely out of the belt slit 112. However, as a user walks around the construction side carrying the fall protection device, the safety belt 40 may extends itself as it overcomes the resilience of the spiral spring 60 and spins the rotary disc 30 and the brake member 50 synchronously around the axle 20.

A ratchet ring 70 housed in the circular space 141, as shown in FIGS. 1, 2, 3, 6, and 7, has an outer wall 71 whose diameter is greater than that of the cylinder 32, and teeth 72 along an inner wall. The brake member 50 is disposed within the ratchet ring 70 surrounded by the teeth 72. When the rotary disc 30 and the brake member 50 synchronously spin normally around the axle 20, the teeth 72 do not interfere. There are a number of axial threads 73 at intervals along the outer wall 71.

A flexible band 80, such as a tolerance ring, has alternately arranged inner threads 81 and first gaps 82 along an inner wall. The band 80 tightly surrounds the outer wall 71 of the ratchet ring 70 and the threads 73 are received in the first gaps 82. The band 80 has alternately arranged outer threads 84 and second gaps 83 along an outer wall, and the band 80 is tightly attached to an inner wall of the metallic ring 14. The ratchet ring 70 is positioned in the circular space 141 through the band 80, which is tightly sandwiched between the metallic ring 14 and the ratchet ring 70. The inner threads 81, the first gaps 82, the outer threads 83, and the outer gaps 84 of the band 80 provide a cushion mechanism between the metallic ring 14 and the ratchet ring 70. When a fall accident occurs, the safety belt 40 is pulled to accelerate the rotary disc 30 to spin. As a pawl block 53 engages teeth 72, the band 80 slows down the rotation of the ratchet ring 70 by offering friction between the ratchet ring 70 and the band 80 and absorbs a portion of the energy of the rotary disc 30's deceleration, so that the speed of the safety belt 40 is continuously slowed down. In the meantime, the threads 73 of the ratchet ring 70 would continue to pass the inner teeth 81 and the first gaps 82, not only producing a series of clicking sounds but also undergoing additional cushion effect. It should be noted that the inner teeth 81 has a smaller width than that of the outer teeth 84. Therefore, the outer teeth 84 suffers a greater torque. The friction between relative rotations generally occurs between the band 80 and the ratchet ring 70. However, when the threads 73 cannot pass the inner teeth 81 and the first gaps 82, friction does occur between the relative rotation between the band 80 and the metallic ring 14, depending on a pre-pressure force between the threads 73 and the inner teeth 81. It should also be noted that the band 80 and the first cover 12 may be integrally formed, as long as the band 80 or the first cover 12 may tightly fit the ratchet ring 70 onto the casing 10 by a pre-pressure force.

The present invention provides the following advantages.

Firstly, the present invention has the band 80 disposed between the ratchet ring 70 and the casing 10, and the ratchet ring 70 has a greater diameter than the cylinder 32. When the band 80 absorbs the fall energy, as shown in FIG. 5, the band 80's radius provides the resistance arm, and the radius of the roll of safety belt 40 provides the force arm. The ratio of the resistance and force arms is close to one, thereby significantly increasing the torque sustainable by the band 80. The reliability of withstanding the torque is also enhanced due to a greater contact surface. The present invention as such may handle greater stress and has wider applicability. It should be noted that the casing 10 may be shaped like inverted U, and has the ratchet ring 70 and the band 80 installed to a side of the casing 10. This structure may also be able to handle greater stress.

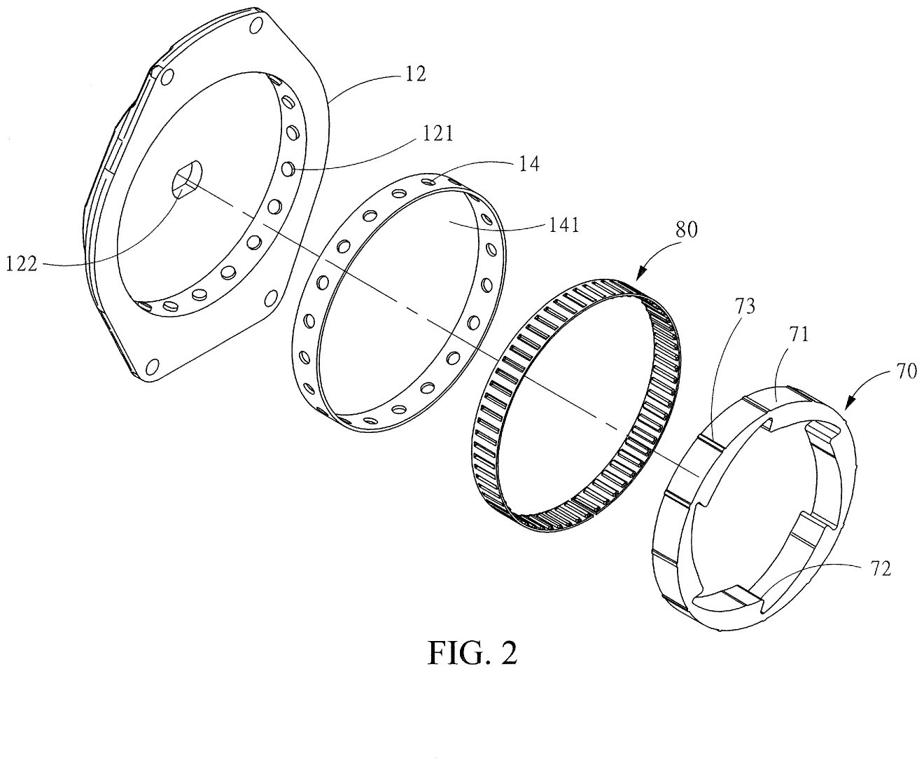

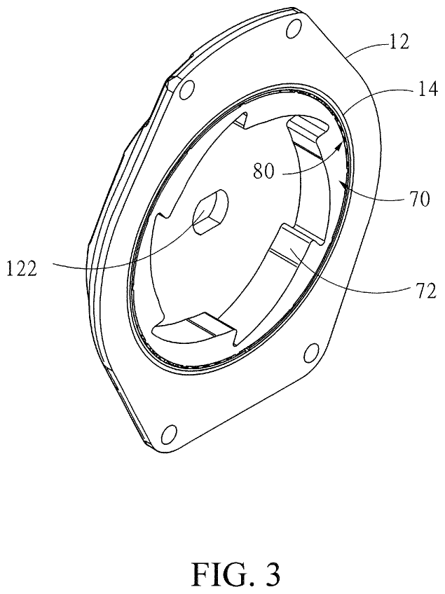

Secondly, as shown in FIGS. 2 and 3, the fall protection device has the advantage of easier recycling and replacement. The first cover 12, the metallic ring 14, the ratchet ring 70, and the band 80 are modularized. After the first cover 12 is removed, new first cover 12, metallic ring, ratchet ring 70, or band 80 may be installed. In addition, the modularization design also provides production that is more economical.

Thirdly, as shown in FIGS. 2, 3, and 7, a first cushion effect is provided by the band 80's having inner teeth 81 and first gaps 82 tightly pressing the outer wall 71 of the ratchet ring 70, and a second cushion effect is achieved by the threads 73's being stopped by the inner teeth 81 and the first gaps 82. Therefore, the present invention provides double cushion effects, achieving greater degree of safety than the teachings of US 09670980B2 and US09861841B1.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A fall protection device, comprising:
a main member having a chamber inside;
an axle running across the chamber;
a rotary disc housed in the chamber comprising a cylinder with an axial channel, where the axle runs through the axial channel, and a roll of safety belt wraps around the cylinder;
a brake member mounted to a side of the rotary disc; and
a ratchet ring having teeth along an inner wall and a greater diameter than that of the cylinder, where the ratchet ring is joined to the main member through a flexible band;
wherein, when the safety belt pulls the rotary disc to accelerate until the brake member engages the ratchet ring's inner teeth, the flexible band slows down the ratchet ring's rotation.

2. The fall protection device according to claim 1, wherein the flexible band comprises a plurality of alternately arranged inner teeth and first gaps along an inner wall; and the inner teeth and first gaps tightly surround the ratchet ring.

3. The fall protection device according to claim 2, wherein the ratchet ring has a plurality of axial threads at intervals along an outer wall of the ratchet ring.

4. The fall protection device according to claim 1, wherein the main member comprises a detachable first cover sealing a side of the chamber; and the flexible band is mounted to an inner side of the first cover.

5. The fall protection device according to claim 4, wherein the first cover has a circular space on the inner side of the first cover; and the flexible band is mounted in the circular space.

6. The fall protection device according to claim 5, wherein the flexible band further comprises a plurality of alternately arranged outer teeth and second gaps along an outer wall; and the outer teeth and second gaps tightly press the circular space.

7. The fall protection device according to claim 5, wherein a metallic ring surrounding the circular space is mounted to the inner side of the first cover; the metallic ring has a plurality of radial plug holes; and the first cover has a plurality of blocks 121 corresponding to the plug holes along an inner wall of an indentation on the inner side of the first cover.

8. The fall protection device according to claim 1, wherein the axle is fixedly housed in the chamber; the axle has an radially protruding limitation element adjacent to a front end of the axle; a back side of the rotary disc has an indentation; a spiral spring is disposed in the indentation with an outer end bound to an inner wall of the indentation and an inner end connected to the axle.

9. The fall protection device according to claim 1, wherein a first side plate is joined to a front side of the cylinder; a second side plate is joined to a back side of the cylinder; the first side plate, the cylinder, and the second side plate jointly form a ring space for accommodating the roll of safety belt; the safety belt has an end bound to the cylinder and another end running through the belt slit; the brake member comprises two pivots and two spring bases oppositely positioned on a front side of the first side plate; a pawl block is pivotally mounted on each pivot; a resilient spring is configured between each spring base to a pawl block so that the pawl block is by default held towards the spring base; and, when the safety belt is pulled and the rotary disc accelerates to a specific speed, the at least a pawl block conquers the spring to engage teeth of the ratchet ring.

10. The fall protection device according to claim 1, wherein the main member comprises a casing, a first cover, and a second cover; the casing provides the chamber; the first cover is detachably joined to a front side and the second cover is detachably joined to a back side of the casing, thereby sealing the chamber; the casing 11 has a hanging ring on a top side for connection to an anchorage and a belt slit on a bottom side allowing the safety belt to pass through.

11. The fall protection device according to claim 2, wherein the main member comprises a detachable first cover sealing a side of the chamber; and the flexible band is mounted to an inner side of the first cover.

12. The fall protection device according to claim 3, wherein the main member comprises a detachable first cover sealing a side of the chamber; and the flexible band is mounted to an inner side of the first cover.

13. The fall protection device according to claim 11, wherein the first cover has a circular space on the inner side of the first cover; and the flexible band is mounted in the circular space.

14. The fall protection device according to claim 12, wherein the first cover has a circular space on the inner side of the first cover; and the flexible band is mounted in the circular space.

15. The fall protection device according to claim 13, wherein the flexible band further comprises a plurality of alternately arranged outer teeth and second gaps along an outer wall; and the outer teeth and second gaps tightly press the circular space.

16. The fall protection device according to claim 14, wherein the flexible band further comprises a plurality of alternately arranged outer teeth and second gaps along an outer wall; and the outer teeth and second gaps tightly press the circular space.

17. The fall protection device according to claim 13, wherein a metallic ring surrounding the circular space is mounted to the inner side of the first cover; the metallic ring has a plurality of radial plug holes; and the first cover has a plurality of blocks 121 corresponding to the plug holes along an inner wall of an indentation on the inner side of the first cover.

18. The fall protection device according to claim 14, wherein a metallic ring surrounding the circular space is mounted to the inner side of the first cover; the metallic ring has a plurality of radial plug holes; and the first cover has a plurality of blocks 121 corresponding to the plug holes along an inner wall of an indentation on the inner side of the first cover.

19. The fall protection device according to claim 2, wherein the axle is fixedly housed in the chamber; the axle has an radially protruding limitation element adjacent to a front end of the axle; a back side of the rotary disc has an indentation; a spiral spring is disposed in the indentation with an outer end bound to an inner wall of the indentation and an inner end connected to the axle.

20. The fall protection device according to claim 3, wherein the axle is fixedly housed in the chamber; the axle has an radially protruding limitation element adjacent to a front end of the axle; a back side of the rotary disc has an indentation; a spiral spring is disposed in the indentation with an outer end bound to an inner wall of the indentation and an inner end connected to the axle.
